(19) United States
(12) Patent Application Publication
(10) Pub. No.: US 2015/0051868 A1
(43) Pub. Date: Feb. 19, 2015

(54) SYSTEM FOR MONITORING ROTATING ELEMENTS

(71) Applicant: General Electric Company, Schenectady, NY (US)

(72) Inventors: Joel Russell Cloninger, II, Anderson, SC (US); William Max Gobeli, Simpsonville, SC (US)

(73) Assignee: General Electric Company, Schenectady, NY (US)

(21) Appl. No.: 13/965,458

(22) Filed: Aug. 13, 2013

(51) Int. Cl. G01M 13/02; G04F 13/00

(52) U.S. Cl. CPC G01M 13/02; G04F 13/00
USPC 702/176

(57) ABSTRACT

A system for monitoring at least one rotating element is provided. The system can include a first sensor substantially aligned with a first rotating element, the first sensor being configured to detect a first marker on the first rotating element and thereby provide a first signal; a second sensor substantially aligned with a second rotating element, the second sensor being configured to detect a second marker on the second rotating element and thereby provide a second signal; and a measurement system coupled with the first sensor and the second sensor, wherein the measurement system is configured to: evaluate a time delay between a detection time of the first signal and a detection time of the second signal.

### BACKGROUND OF THE INVENTION

An embodiment of the present disclosure relates generally to rotating elements, including components of rotary apparatuses such as gas and wind turbines. More particularly, to a system capable of measuring performance variables in such applications.

Generally, rotating can include any form of rotatable component, such as a shaft. These components can be connected by intervening elements, such as a slip coupling or high torque coupling element. One component can also include multiple sections and/or continuous sections.

When a rotating element is subjected to high torque, one component can slip relative to another component or become deformed. For example, a slip coupling can be used to cause one shaft or shaft section to slip rotatably, relative to another shaft or shaft section, when the coupling is subjected to a predetermined amount of torque. Slip elements or similar couplings can be used to reduce or eliminate undesired spikes in performance attributes, such as component torque or speed, and result in one component or shaft having a rotational displacement relative to another component or shaft, which can be quantified as a “slip angle.”

As a further example, torque can cause rotational deformation, twisting, or torsion at one section of a rotating shaft relative to another shaft section. This rotational displacement can be quantified as “windup.” Methods for calculating slip, windup, and other performance variables can include installing one or more rotary potentiometers within a rotating element. Other measurement equipment also can include using potentiometers with digital encoders with some components, located outside a rotating element. Systems using these approaches can be difficult or expensive to install, modify, or remove.

### BRIEF DESCRIPTION OF THE INVENTION

A first aspect of the disclosure provides a system for monitoring at least one rotating element, the system comprising: a first sensor substantially aligned with a first rotating element, the first sensor being configured to detect a first marker on the first rotating element and thereby provide a first signal; a second sensor substantially aligned with a second rotating element, the second sensor being configured to detect a second marker on the second rotating element and thereby provide a second signal; and a measurement system coupled with the first sensor and the second sensor, wherein the measurement system is configured to: evaluate a time delay between a detection time of the first signal and a detection time of the second signal.

A second aspect of the disclosure provides a system for monitoring at least one rotating element, the system comprising: a first signaling device configured to transmit a first reflective signal to a first rotating element; a second signaling device configured to transmit a second reflective signal to a second rotating element; a first sensor substantially aligned with the first rotating element, wherein the first sensor is configured to detect the first reflective signal; a second sensor substantially aligned with the second rotating element, wherein the second sensor is configured to detect the second reflective signal; and a measurement system coupled to the first and second sensors, wherein the measurement system is configured to: evaluate a time delay between a detection time of the first reflective signal and a detection time of the second reflective signal.

A third aspect of the invention includes a system for monitoring at least one rotating element, the system comprising: a first signaling device substantially aligned with a first rotating element, wherein the first signaling is configured to send and receive a first reflective signal by reflecting the first reflective signal from the first rotating element; a second signaling device substantially aligned with a second rotating element, wherein the second signaling device is configured to send and receive a second reflective signal by reflecting the second reflective signal from the second rotating element, and the first and second rotating elements are independently rotatable and rotatably coupled to a coupling component; and a measurement system coupled to the first signaling device and the second signaling device, wherein the measurement system comprises a processing component configured to evaluate a time delay between a detection time of the first reflective signal and a detection time of the second reflective signal, and the processing component is further configured to compute, from the evaluated time delay, a slip angle between the first rotating element and the second rotating element.

### BRIEF DESCRIPTION OF THE DRAWING

These and other features of the disclosed system will be more readily understood from the following detailed description of the various aspects of the system taken in conjunction with the accompanying drawings that depict various embodiments, in which:

FIG. 1 is a schematic diagram of a system for monitoring rotatably coupled rotating elements according to an embodiment of the disclosure.

FIG. 2 is a schematic diagram of a system for system for monitoring rotating elements of a rotary apparatus according to an embodiment of the disclosure.

FIG. 3 is a schematic diagram of a system for system for monitoring a slip angle between rotating elements of a rotary apparatus according to an embodiment of the disclosure.

FIG. 4 is a schematic diagram of a system for system for monitoring a windup value between rotating elements according to an embodiment of the disclosure.

FIG. 5 is a plot in which a slip angle measured by an embodiment of the disclosed system over a time is compared with a slip angle measured by a rotary potentiometer over the same time.

It is noted that the drawings are not necessarily to scale. The drawings are intended to depict only typical aspects of the disclosure, and therefore should not be considered as limiting its scope. In the drawings, like numbering represents like elements between the drawings.

### DETAILED DESCRIPTION OF THE INVENTION

In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely illustrative.

When an element or layer is referred to as being “on,” “connected to,” or “coupled to” another element or layer, it may be directly on, engaged, connected or coupled to the other element or layer, or intervening elements or layers may be present. In contrast, when an element is referred to as being “directly on,” ““directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Spatially relative terms, such as “inner,” “outer,” “beneath”, “below”, “lower”, “above”, “upper,” “inlet,” “outlet” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, when the systems in the figures are turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

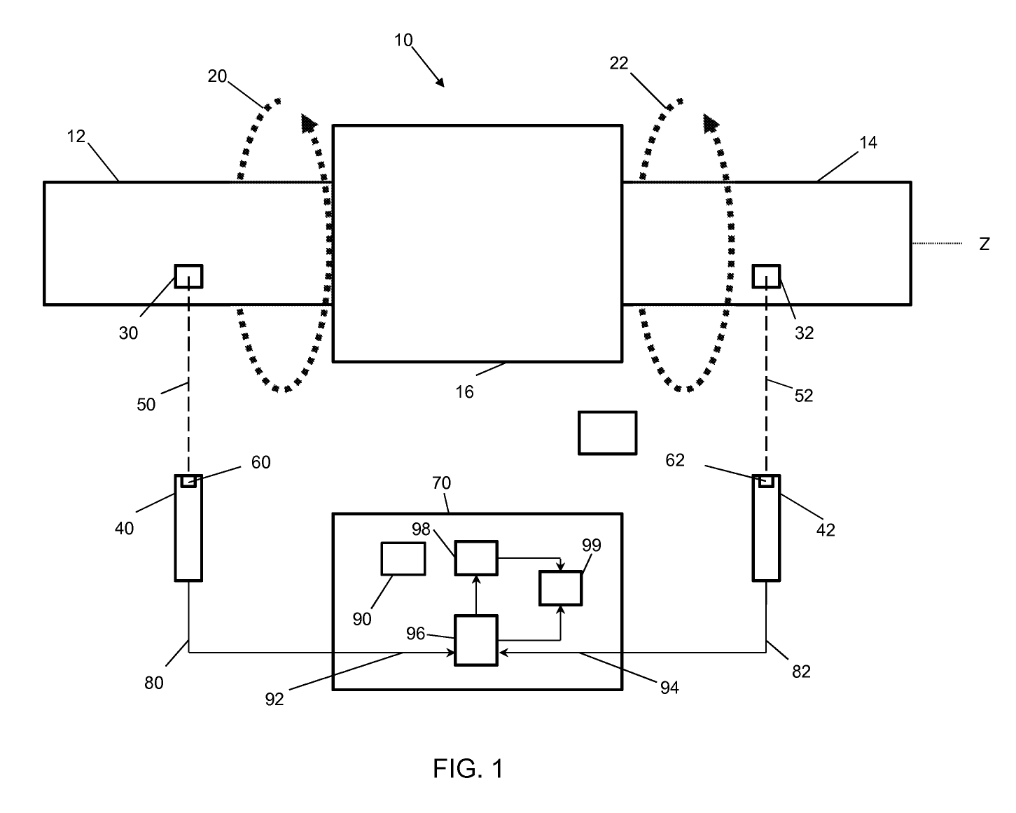

Referring to the drawings, FIG. 1 depicts a system 10 for monitoring one or more rotating elements according to an embodiment of the invention. System 10 can be configured to monitor a first rotating element 12 and a second rotating element 14. Either or both of first and second rotating elements 12, 14 can have cylindrical geometries or other geometries capable of rotational motion about an axis. First and second rotating elements 12, 14 can also be independently rotatable and rotatably coupled to a coupling component 16. Coupling component 16 can include, for example one or more high torque slip elements to which rotating elements can be rotatably connected, including torque limiters, element clutches, slip hubs, and torque converters. First rotating element 12 and second rotating element 14 can be independently rotatable as depicted by a first rotation motion 20 and a second rotation motion 22. First rotating element 12 can be provided with a first marker 30 and second rotating element 14 can be provided with a second marker 32. In FIG. 1, first rotating element 12 and second rotating element 14 are shown rotating in a substantially synchronous fashion about central axis Z.

System 10 can include a first sensor 40 and a second sensor 42 for monitoring first and second rotating elements 12, 14. First sensor 40 is shown to have a first line of substantial alignment 50 with first rotating element 12. As described herein, first sensor 40 can detect first marker 30 located on first rotating element 12. Similarly, second sensor 42 is shown to have a second line of substantial alignment 52 with rotating element 14. Second sensor 42 can similarly detect second marker 32 located on second rotating element 14. As also described herein, system 10 can include a first signaling device 60 and a second signaling device 62. In some embodiments, first and second signaling devices 60, 62 can each be coupled to first and second sensors 40, 42 to form a single component. First sensor 40 and/or second sensor 42 can be coupled to a measurement system 70 by a first coupling line 80 and a second coupling line 82, which can be provided as a mechanical coupling, electrical coupling, wireless coupling, or other appropriate coupling mechanisms currently known or later developed.

First and second lines of substantial alignment 50, 52 need not be configured to provide exact, pinpoint or complete alignment between first sensor 40 and first marker 30 or between second sensor 42 and second marker 32. The terms “substantial alignment,” “substantially aligned,” and their equivalents as used in the present disclosure refer to any alignment through which first and second sensors 40, 42 are capable of detecting first and second markers 30, 32. Conversely, alignment would not be “substantial” when first and second sensors 40, 42 cannot detect first marker 30 and/or second marker 32.

In some embodiments, first and second sensors 40, 42 can be configured to detect first and/or second markers 30, 32. Accordingly, first and second sensors 40, 42 can include at least one of the following mechanisms by way of example: optical sensors, electric sensors, magnetic sensors, mechanically actuated switches, laser sensors, capacitive sensors, inductive sensors, optical sensors, cameras, piezoelectric sensors, Hall Effect sensors, and similar devices configured to detect first and/or markers 30, 32. First and second sensors 40, 42 can either operate continuously or be activated by first and/or second markers 30, 32.

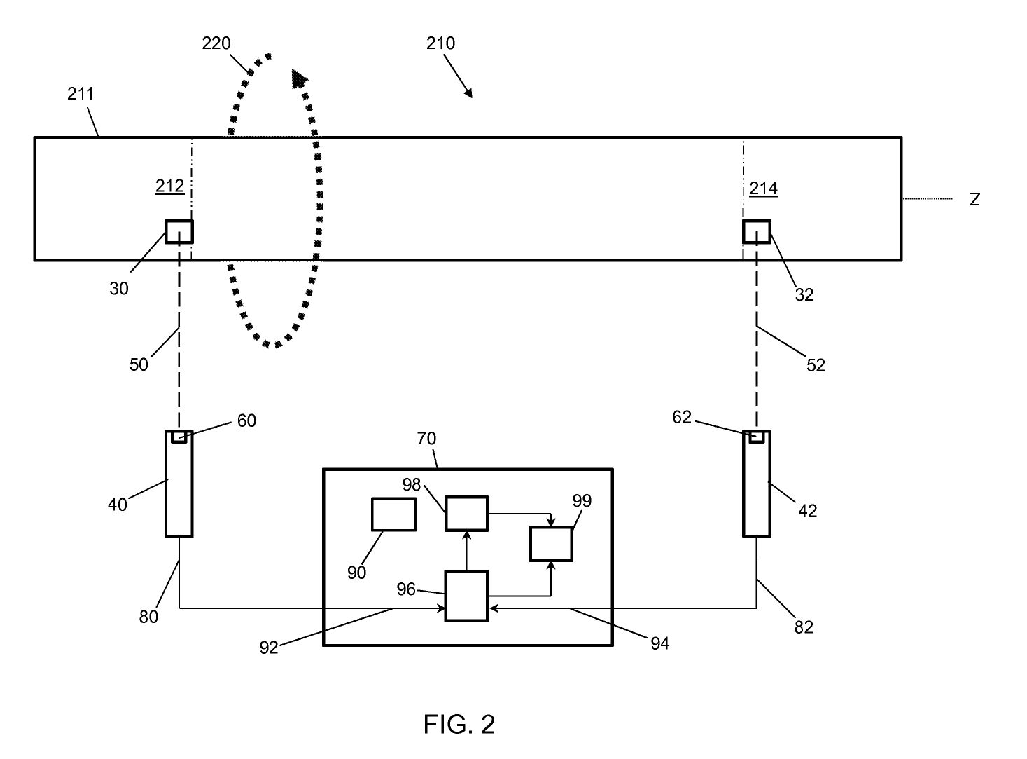

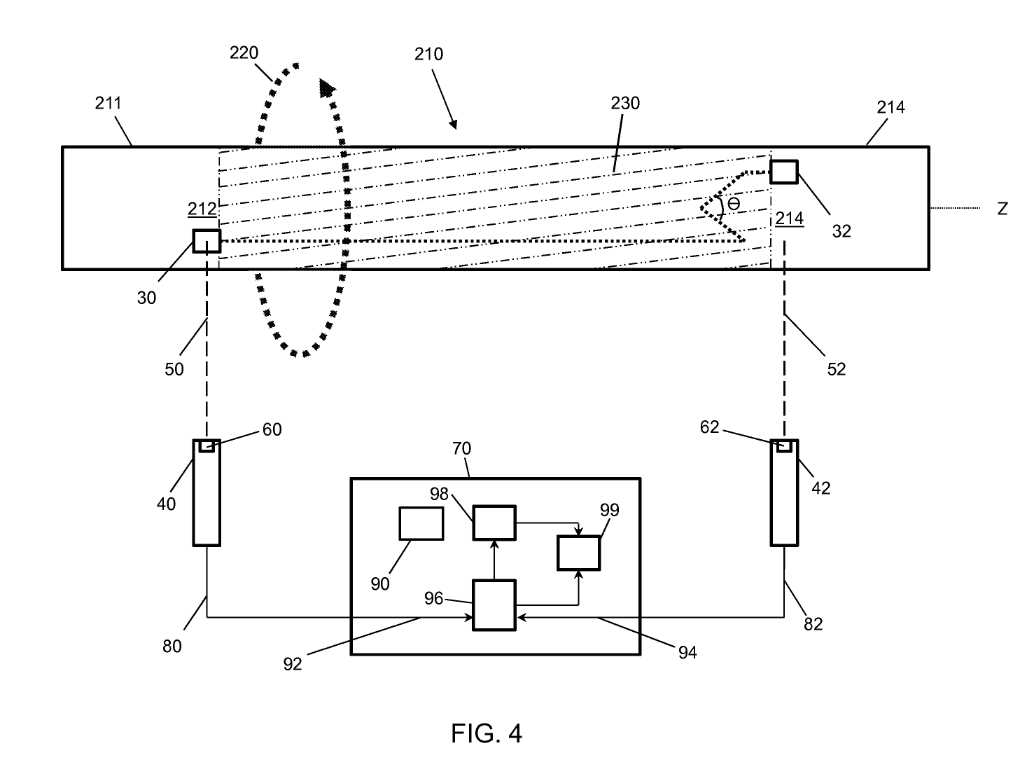

In other embodiments of the disclosure, system 10 and a system 210 (FIGS. 2, 4) can further include signaling devices 60, 62 which can be configured to generate a reflective signal. A “reflective signal” is so named because the signal can be reflected by markers 30, 32 and/or received by first and or/second sensors 40, 42. Either or both of first and second markers 30, 32 therefore can be reflectors configured to reflect a corresponding reflective signal. First and second signaling devices 60, 62 are optional, but these components are depicted by example in both systems 10, 210 of FIGS. 1-4. When first and second signaling devices 60, 62 are included, the signal detection components of system 10 can be modified as described elsewhere herein.

Embodiments of the present disclosure contemplate that first and second markers 30, 32 can be any component or part capable of being detected by first and second sensors 40, 42. First and/or second marker 30, 32 can therefore be one or more of a reflective marker, a laser, a magnetic field, an electric field, an optical signal, a retroreflector, a rivet, a bolt, or another structural component capable of detection by corresponding equipment used in first and second sensors 40, 42.

A measurement system 70 can be coupled to first and second sensors 40, 42 via coupling lines 80, 82, and further can be configured to monitor one or more rotating elements. Measurement system 70 can optionally include a processing component 90 to perform the operations discussed herein. Processing component 90 of Measurement system 70 can include a computer, computer processor, electric or digital circuit, and/or a similar component used for computing and processing. To monitor one or more rotating elements, measurement system 70 can receive first signal 92 and second signal 94, with each signal including a corresponding detection time for first marker 30 and second marker 32. First and second signals 92, 94, which can be generated by first and second sensors 40, 42, can be distinct signals or one type of signal detected by each sensor.

Measurement system 70 can be configured to evaluate a time delay 96, represented by a comparison or difference between a time at which first signal 92 is detected and a time at which second signal 94 is detected. The ability for measurement system 70 to process first and second signals 92, 94 and evaluate time delay 96 can be provided by processing component 90. Evaluated time delay 96 can be provided directly to a user by measurement system 70, or can use time delay 96 to calculate a performance variable 98. As further discussed herein, performance variable 98 can include one or more of a slip angle, a windup value, or another measurement of rotational displacement between two or more rotating elements. Outputs from measurement system 70 can optionally be provided through a display or data output 99.

FIG. 2 depicts another embodiment of the disclosure, which includes an embodiment of a system 210 configured to monitor several rotating elements within the same rotary apparatus 211. The system is depicted in FIG. 2 as monitoring a rotary apparatus 211 with a first rotating element in the form of a first section 212 and a second rotating element in the form of a section 214. Rotary apparatus 211 is depicted as having rotation motion 220. Rotary apparatus 211 can be provided with a first marker 30 at a first section 212 and a second marker 32 at a second section 214. In FIG. 2, no apparent windup or deformation is present in rotary apparatus 211, thereby causing first and second sections 212, 214 to rotate in a substantially synchronous fashion about central axis Z.

Similar to system 10 described elsewhere herein, first sensor 40 is shown to have first line of substantial alignment 50 with first section 212. The structure of first sensor 40 is described elsewhere herein. First sensor 40 can detect first marker 30 located on a first section 212 of rotary apparatus 211. First sensor 40 can be coupled to a measurement system 70 by first coupling line 80, which can include a mechanical coupling, electrical coupling, or another appropriate mechanism. As first sensor 40 detects first marker 30 crossing first line of substantial alignment 50, first sensor 40 can create first signal 92 which can be transmitted measurement system 70 through first coupling line 80.

Second sensor 42 is similarly shown to have second line of substantial alignment 52 with second section 214. The structure of second sensor 42 is described elsewhere herein. Second sensor 42 therefore can detect second marker 32 of second section 214 when second marker 32 passes second line of substantial alignment 52. Second sensor 42 can also be coupled to measurement system 70 by second coupling line 82, which can include a mechanical coupling, electrical coupling, wireless coupling, or another mechanism currently known or later developed. In response to second sensor 42 detecting second marker 32, second sensor 42 creates second signal 94 for transmission to measurement system 70 through second coupling line 82.

Similar to embodiments shown elsewhere herein, the embodiment illustrated in FIG. 2 can also optionally include first and second signaling devices 60, 62, which can transmit reflective signals to first and second sections 212, 214 of rotary apparatus 211. First and second signaling devices 60, 62 in some embodiments can be part of the same component as first and second sensors 40, 42. However, embodiments in which first and second signaling devices 60, 62 are coupled to but separated from first and second sensors 40, 42 are also contemplated.

Measurement system 70 shown in FIG. 2, and its corresponding components can be the same as measurement system 70 of FIG. 1, even though the rotating elements under examination have been changed. As described elsewhere herein, measurement system 70 can receive first signal 92 from first sensor 40 and second signal 94 from second sensor 42. Measurement system 70 can then evaluate a time delay 96, optionally with the aid of processing component 90. Measurement system 70 can optionally use time delay 96 to calculate performance variable 98, optionally with the aid of processing component 90. Time delay 96 and/or performance variable 98 can be yielded to display or data output 99. In the situation depicted in FIG. 2, evaluated time delay 96 would have a value substantially equal to zero because no significant windup is shown to be present between sections 212, 214 of rotary apparatus 211. In addition, embodiments of system 210 can also use similar or identical components as embodiments of system 10, with optional modifications to accommodate different rotating elements.

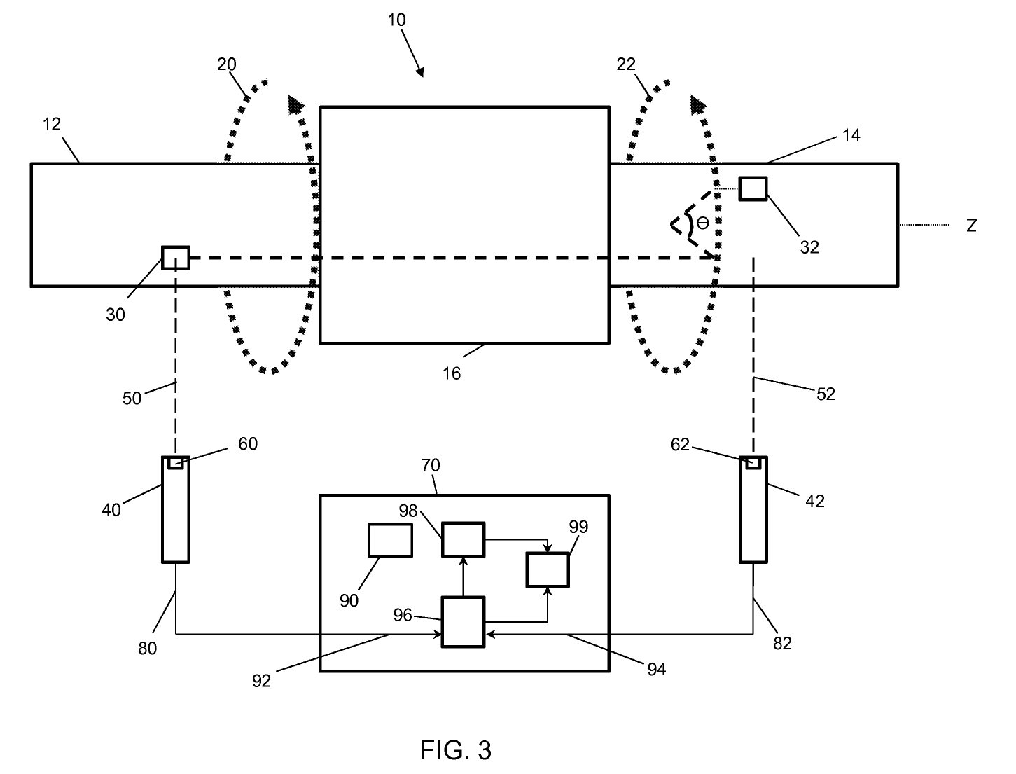

Turning to FIGS. 3 and 4, manners in which systems 10, 210 can operate according to embodiments of the invention will now be disclosed. In FIG. 3, system 10 is depicted as having a first rotating element 12 and second rotating element 14 that have similar first and second rotation motions 20, 22. As shown in FIG. 3, rotational displacement in the form of a “slip angle” is present between first rotating element 12 and second rotating element 14, illustrated by the difference in angular position between first and second markers 30, 32 about axis Z. The slip angle between each rotating element 12, 14 is denoted by angle θ about the central axis Z of second rotating element 14. Although FIG. 3 depicts first rotating element 12 and second rotating element 14 as sharing a common central axis Z, the angle θ of rotational displacement in other embodiments can be measured with respect to a different reference axis or point as desired.

As first sensor 40 detects first marker 30 passing first line of substantial alignment 50, first sensor 40 can signal measurement system 70 through first coupling line 80 to provide first signal 92 to measurement system 70. Similarly, second sensor 42 can detect second marker 32 crossing second line of substantial alignment 52 with second rotating element 14. Second sensor 42 therefore can detect a second marker 32 located on second rotating element 14. Second sensor 42 can also be coupled to measurement system 70 by a second coupling line 82, which can include mechanical coupling, electrical coupling, wireless coupling, and/or other appropriate mechanism currently known or later developed. This second coupling line 82 can allow second sensor 42 to provide second signal 94 to measurement system 70.

In FIG. 3, system 10 is shown to have slip angle θ about central axis Z. System 10 can identify the presence of slip angle θ because second sensor 42 does not detect second marker 32 at the same time that first sensor 40 detects first marker 30, therefore indicating a delay between first and second signals 90, 92. Thus, measurement system 70 will return a non-zero value for time delay 96. In addition, the non-zero time delay 96 can be used to compute performance variable 98, such as a slip angle. For example, as described in further detail herein, time delay 96 converts to an angular value when multiplied by a rotational speed or velocity.

Similarly, in FIG. 4, system 210 is shown to have rotational displacement in the form of a “windup value” between first and second sections 212, 214 of rotary apparatus 211, similarly denoted by angle θ about central axis Z. This deformation or windup causes a delay between when first and second sensors 40, 42 detect first and second markers 30, 32. Thus, time delay 96 evaluated by measurement system 70 would have a value greater than zero. Also, time delay 96 can be used to compute a performance variable 98 in the form of a windup value. For example, as described in further detail herein, time delay 96 converts to a windup angle when multiplied by a rotational speed or velocity. Although FIG. 4 depicts first and second sections 212, 214 of rotary apparatus 211 as sharing a common central axis Z, the angle θ of rotational displacement in other embodiments can be measured with respect to a different reference point as desired.

As demonstrated by the discussion of FIGS. 1-4, embodiments of the disclosure can be modified for use in several situations, such as evaluating a time delay between any two points of one or more rotating elements. Embodiments of the disclosure therefore encompass numerous configurations and designs for monitoring rotating elements, including systems with both signaling devices and sensors.

Systems 10, 210 can be modified to incorporate signaling devices, as an addition or an alternative to any sensors. Systems 10, 210 can include first signaling device 60 which can be configured to transmit a first reflective signal to first marker 30 of first rotating element 12 (FIGS. 1, 3) or first section 212 of rotary apparatus 211 (FIGS. 2, 4). Second signaling device 62 can similarly be configured to transmit a second reflective signal to marker 32 on either a second rotating element 14 (FIGS. 1, 3) or a second section 212 of rotary apparatus 211 (FIGS. 2, 4). The first and second reflective signals can be reflected by first marker 30 and/or second marker 32. The reflective signals can afterwards be received by either first sensor 40 or second sensor 42 aligned with one or more rotating elements by lines of substantial alignment 50, 52, respectively.

In this context, either or both of the two markers 30, 32 can be reflectors connected to first rotating element 12, second rotating element 14, or first and second sections 212, 214 of a single rotary apparatus 211. As “reflectors,” one or both of markers 30, 32 can include one or more of the following components: electric fields, magnetic fields, reflective markers, retroreflectors, rivets, bolts, structural components and similar items which can reflect corresponding reflective signals back to first and/or second sensors 40, 42.

With respect to the embodiments of system 10 disclosed in FIG. 1 and FIG. 3, in which first and second rotating elements 12, 14 can be independently rotatable, measurement system 70 is capable of detecting a time delay in multiple configurations. For example, first rotating element 12 can include one or more drive shafts and/or generator shafts in turbines or similar devices. Similarly, second rotating element 14 can include drive shafts and/or generator shafts in turbines or other systems which include rotating elements. In some embodiments, measurement system 70 can be configured to evaluate a time delay between any two rotating elements (e.g. 12, 14), such as the time delay between rotating drive shafts and/or rotating generator shafts.

In embodiments in which system 210 is used to monitor rotating elements in the form of first and second sections 212, 214 of one rotary apparatus 211, specific types of rotary apparatuses can also be monitored. For example, system 210 can be configured to monitor a single rotary apparatus 211 in the form of a drive shaft or a generator shaft. In other embodiments, first and/or second sections 212, 214 can be part of a drive shaft or a generator shaft. Thus, time delay 96 evaluated by measurement system 70 can be configured to monitor rotating elements with drive and generator shafts, or shaft sections with similar functions.

As discussed elsewhere herein, performance variable 98 can include any final or intermediate variable pertaining to one or more rotating elements, having dimensional or non-dimensional values, which can be derived from values of time delay 96. For example, performance variable 98 derived from evaluated time delay 96 can be a value θ representing a slip angle between two or more independently rotatable rotating elements 12, 14 (FIGS. 1, 3), a windup value between two or more sections 212, 214 of the same rotary apparatus 211 (FIGS. 2, 4), or a similar value for rotational displacement or deformation. A user or processing component 90 can mathematically derive performance variable 98 from time delay 96. An example expression for finding value θ can be written as:

θ=ω(Δt)

In this example equation, the variable θ can generally represent a rotational displacement such as a slip angle or windup value between first marker 30 and second marker 32 corresponding to two rotating elements. The variable ω can represent a rotational or angular velocity of two rotating elements, including independently rotatable rotating elements or two sections of the same rotary apparatus. The variable ω can include revolutions per unit time (e.g. hours, minutes, seconds etc.), cycles per unit time, radians per unit time, degrees per unit time, and similar measures of angular speed or velocity. The variable Δt can represent an evaluated time delay 96.

An advantage that may be realized in the practice of some embodiments of the described systems, when remote sensors are used to monitor rotating elements, other monitoring equipment may not need to be installed on the rotating element itself. This design advantage can reduce costs and improve performance of a rotating element. A further advantage that can be available in some embodiments of the described systems is that the system can be used with non-hollow (“solid”) shafts, allowing variables to be tracked in a wide variety of implementations. Embodiments of the disclosure can be configured to monitor hollow shafts, in which a rotary potentiometer can be employed. Other slip or windup monitoring systems can be either removed or used in tandem with a system according to embodiments of the disclosure.

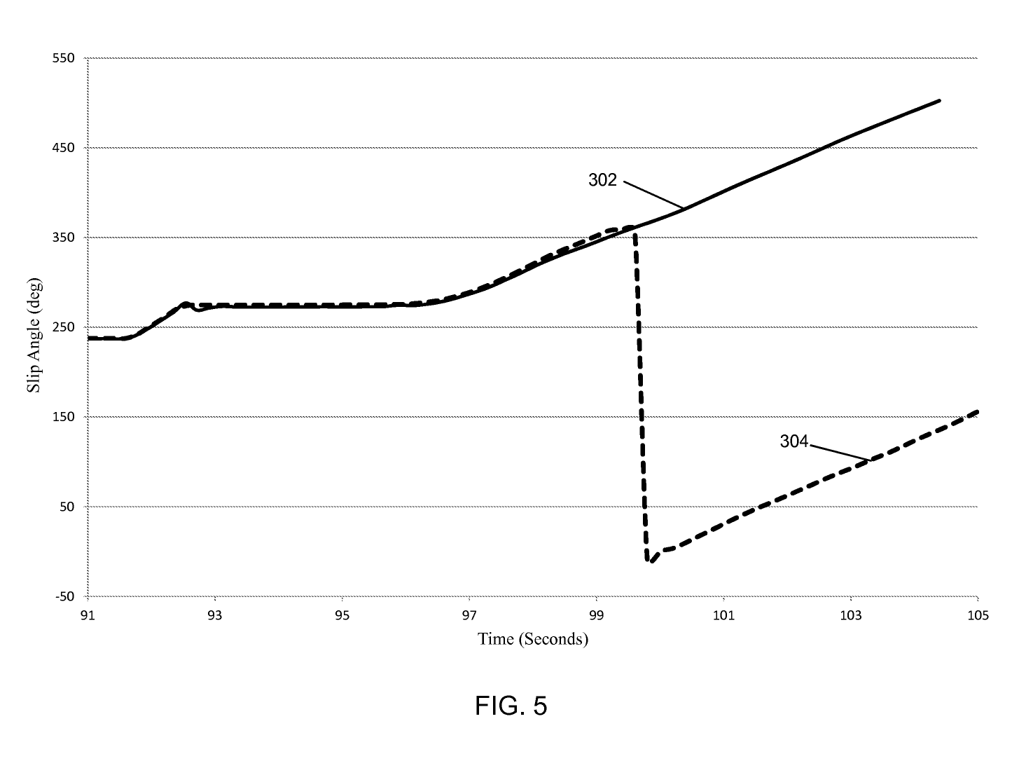

FIG. 5 displays a further advantage that can be obtained from embodiments of the disclosed system. The graph represented in FIG. 5 represents two evaluations of slip angle over time. One evaluation (marked by solid plot 302) was performed by an embodiment of the disclosure, while another evaluation (marked by dash plot 304) was performed by a rotary potentiometer system. According to the graph shown in FIG. 5, a system according to the disclosure can provide slip angle data that is more accurate than a conventional rotary potentiometer system. As shown by the plot of FIG. 5, slip angle would continue to increase as one or more rotating elements are subjected to increased torque as shown in solid plot 302, and would not exhibit the asymptotic behavior shown in dash plot 304 corresponding to conventional systems.

The systems and devices of the present disclosure are not limited to any one particular application and can be provided in a variety of implementations, such as an engine, turbine, jet engine, generator, power generation system or other system. In addition, the systems and devices of the present disclosure may be used with other aircraft systems, power generation systems and/or systems (e.g., combined cycle, simple cycle, nuclear reactor, etc.). For example, embodiments of the disclosed system can be configured to monitor or determine the relative position one or more rotating elements including steam turbines, gas turbines, wind turbines, generators, engines, paper machines, motors, and/or similar components in transportation systems, such engines and components in cars, trains ships, and jets. In other embodiments, the disclosed systems can be configured to monitor equipment in industrial processes, mining systems, transportation systems, power generation systems, pumps, fans, and liquid processing. Additionally, systems according to embodiments of the present invention may be used with other systems not described herein that may benefit from the monitoring of time delays and performance variables described herein.

Some embodiments of the disclosure can further be configured to evaluate time delays and performance variables from multiple processes linked by time, and thereby determine how a sequence or operation is subjected to change. Specifically, embodiments of the disclosure can be configured to evaluate clocking and delays between two different ends of a shaft or clocking between independent process components.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or” comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for monitoring at least one rotating element, the system comprising:
a first sensor substantially aligned with a first rotating element, the first sensor being configured to detect a first marker on the first rotating element and thereby provide a first signal;
a second sensor substantially aligned with a second rotating element, the second sensor being configured to detect a second marker on the second rotating element and thereby provide a second signal; and
a measurement system coupled with the first sensor and the second sensor, wherein the measurement system is configured to:
evaluate a time delay between a detection time of the first signal and a detection time of the second signal.

2. The system for monitoring at least one rotating element of claim 1, wherein the measurement system further comprises a processing component operative to evaluate the time delay.

3. The system for monitoring at least one rotating element of claim 1, wherein the first rotating element includes a first section of a rotary apparatus and the second rotating element includes a second section of the same rotary apparatus, and the measurement system calculates a windup value between the first section of the rotary apparatus and the second section of the rotary apparatus.

4. The system for monitoring at least one rotating element of claim 3, wherein the windup value is calculated by an equation θ=ω(Δt), wherein θ is a windup value between the first section of the rotary apparatus and the second section of the rotary apparatus, ω is an angular velocity of one of the first section of the rotary apparatus and the second section of the rotary apparatus, and Δt is the evaluated time delay.

5. The system for monitoring at least one rotating element of claim 3, wherein the rotary apparatus comprises one of a generator shaft and a drive shaft.

6. The system for monitoring at least one rotating element of claim 1, wherein the first rotating element is distinct from the second rotating element, and the measurement system calculates a slip angle between the first rotating element and the second rotating element.

7. The system for monitoring at least one rotating element of claim 6, wherein the second rotating element comprises one of a drive shaft and a generator shaft.

8. The system for monitoring at least one rotating element of claim 6, wherein the first and second rotating elements are independently rotatable and rotatably coupled to a coupling component.

9. The system for monitoring at least one rotating element of claim 6, wherein the slip angle is calculated by an equation θ=ω(Δt), wherein θ is a slip angle between the first rotating element and the second rotating element, ω is an angular velocity of one of the first section of the rotary apparatus and the second section of the rotary apparatus, and Δt is the evaluated time delay.

10. The system for monitoring at least one rotating element of claim 1, wherein one of the first sensor and the second sensor comprises one of an optical sensor, an electric sensor, a magnetic sensor, and a mechanically actuated switch.

11. A system for monitoring at least one rotating element, the system comprising:
a first signaling device configured to transmit a first reflective signal to a first rotating element;
a second signaling device configured to transmit a second reflective signal to a second rotating element;
a first sensor substantially aligned with the first rotating element, wherein the first sensor is configured to detect the first reflective signal;
a second sensor substantially aligned with the second rotating element, wherein the second sensor is configured to detect the second reflective signal; and
a measurement system coupled to the first and second sensors, wherein the measurement system is configured to:
evaluate a time delay between a detection time of the first reflective signal and a detection time of the second reflective signal.

12. The system for monitoring at least one rotating element of claim 11, wherein a reflector coupled to the first rotating element reflects the first reflective signal.

13. The system for monitoring at least one rotating element of claim 12, wherein a reflector coupled to the second rotating element reflects the second reflective signal.

14. The system for monitoring at least one rotating element of claim 11, wherein the first signaling device is coupled to the first sensor.

15. The system for monitoring at least one rotating element of claim 14, wherein the second signaling device is coupled to the second sensor.

16. The system for monitoring at least one rotating element of claim 11, wherein the first signaling device is further configured to transmit the first reflective signal to a first marker coupled to the first rotating element, and the second signaling device is further configured to transmit the second reflective signal to a second marker coupled to the second rotating element.

17. The system for monitoring at least one rotating element of claim 16, wherein one of the first marker and the second marker comprises one of a reflective marker, a light, a structural component, a magnetic field, and an electric field.

18. The system for monitoring at least one rotating element of claim 11, wherein the first rotating element includes a first section of a rotary apparatus and the second rotating element includes a second section of the same rotary apparatus, and the measurement system calculates a windup value between the first section of the rotary apparatus and the second section of the rotary apparatus.

19. The system for monitoring at least one rotating element of claim 11, wherein the first rotating element is distinct from the second rotating element, and the measurement system calculates a slip angle between the first rotating element and the second rotating element.

20. A system for monitoring at least one rotating element, the system comprising:
a first signaling device substantially aligned with a first rotating element, wherein the first signaling is configured to send and receive a first reflective signal by reflecting the first reflective signal from the first rotating element;
a second signaling device substantially aligned with a second rotating element, wherein the second signaling device is configured to send and receive a second reflective signal by reflecting the second reflective signal from the second rotating element, and the first and second rotating elements are independently rotatable and rotatably coupled to a coupling component; and
a measurement system coupled to the first signaling device and the second signaling device, wherein the measurement system comprises a processing component configured to evaluate a time delay between a detection time of the first reflective signal and a detection time of the second reflective signal, and the processing component is further configured to compute, from the evaluated time delay, a slip angle between the first rotating element and the second rotating element.
